(19) United States
(12) Patent Application Publication
(10) Pub. No.: US 2020/0034893 A1
(43) Pub. Date: Jan. 30, 2020

(54) SOCIAL INFUSION OF MEDIA CONTENT

(71) Applicant: INTERNATIONAL BUSINESS MACHINES CORPORATION, Armonk, NY (US)

(72) Inventors: Kelley L. Anders, East New Market, MD (US); Lisa Seacat DeLuca, Baltimore, MD (US); Jeremy R. Fox, Georgetown, TX (US); Jeremy A. Greenberger, San Jose, CA (US)

(21) Appl. No.: 16/048,434

(22) Filed: Jul. 30, 2018

(51) Int. Cl. G06Q 30/02; G06F 17/30

(52) U.S. Cl. CPC G06Q 30/0282; G06F 17/30663; G06F 17/30867; G06Q 50/01; G06F 17/30991; G06F 17/30997; G06Q 30/0208

(57) ABSTRACT

A method, computer system, and a computer program product for recommending a media content is provided. The present invention may include detecting a user post on a social network platform. The present invention may also include extracting a tag from the user post, wherein the extracted tag is representative of a topic in the user post. The present invention may then include identifying a data content in a repository related to the extracted tag. The present invention may include sending the identified data content to a user for inclusion in the user post upon a user approval. The present invention may include, in response to receiving the user approval, modifying the user post by appending the identified data content to the user post. The present invention may then include transmitting the modified user post to the social network platform.

### BACKGROUND

The present invention relates generally to the field of computing, and more particularly to digital communication.

Media content, such as images, videos, and other graphics, are important factors in successful digital communication, such as, social media publishing. When a user post published on a social network platform includes representative images, videos, or other graphics, the odds of audience engagement with the user post increase significantly. Still, many users fail to appreciate the importance of media content for engaging digital communication and continue to publish user posts on social network platforms without representative media content.

### SUMMARY

Embodiments of the present invention disclose a method, computer system, and a computer program product for recommending a media content for social media publishing. The present invention may include detecting a user post on a social network platform. The present invention may also include extracting a tag from the detected user post, wherein the extracted tag is representative of a topic identified in the detected user post. The present invention may then include identifying a data content in a repository related to the extracted tag. The present invention may further include sending the identified data content to a user device for inclusion in the detected user post upon a user approval. The present invention may also include, in response to receiving the user approval, modifying the detected user post by appending the identified data content to the detected user post. The present invention may then include transmitting the modified user post to the social network platform.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for registering a company associated with tag-based content delivery according to at least one embodiment;

FIG. 3 is an operational flowchart illustrating a media recommending process for tag-based content delivery according to at least one embodiment;

FIG. 4 is an operational example illustrating a media recommending process for tag-based content delivery according to at least one embodiment;

FIG. 5 is a block diagram of internal and external components of computers and servers depicted in FIG. 1 according to at least one embodiment;

FIG. 6 is a block diagram of an illustrative cloud computing environment including the computer system depicted in FIG. 1, in accordance with an embodiment of the present disclosure; and

FIG. 7 is a block diagram of functional layers of the illustrative cloud computing environment of FIG. 6, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for media recommendation processing and delivery in social media publishing. As such, the present embodiment has the capacity to improve the technical field of digital communication by detecting a user post on a social network platform having no associated media content and generating a platform through which companies may provide the user with representative media content for inclusion in the user post based on identified tags in the user post, where the representative media content is associated with products or services of a company.

More specifically, company profiles may be initialized, and company data content may be collected and indexed under the respective company profile. The company data content may include, media content or pointers to media content associated with branded products and services, and tags, such as, keywords, sentiments, common themes, contexts, iconic symbols, and any descriptors linked to the collected media content. Then, the initialized company profiles with the collected company data may be uploaded to a cloud system for storage in a repository and for distribution over a network to social network platforms. Thereafter, a social network platform may be monitored to detect a user post having no media content. When a potential user post is detected, the user post may be analyzed to identify tags that match (e.g., either exactly or approximately) with tags linked to media content provided by a company and stored in the repository. Next, the media content of the company associated with the matched tags may be identified from the repository. Then, the user device may receive an alert or notification (e.g., via push notification) including the suggested media content linked to the company for inclusion in the user post, where the suggested media content may be representative of the user post. Additionally, the notification may include a user incentive for including the suggested media content in the user post. In response to the user accepting the suggested media content, the media content may be retrieved from the repository and appended to the user post to modify the user post. Then, the modified user post may be transmitted to the social network platform for publishing.

As described previously, media content, such as images, videos, and other graphics, are important factors in successful digital communication, such as, social media publishing. When a user post published on a social network platform includes representative images, videos, or other graphics, the odds of audience engagement with the user post increase significantly. Still, many users fail to appreciate the importance of media content for engaging digital communication and continue to publish user posts on social network platforms without representative media content.

Therefore, it may be advantageous to, among other things, provide a way to detect a user post on a social network platform without associated media content. In order to improve the effectiveness of the digital communication by the user and increase the odds of audience engagement with the published user post, it may be advantageous to identify keywords or other tags in the user post that may be linked to a product or service of a company and suggest corresponding media content from a company for inclusion in the published user post. To that end, it may also be advantageous to provide a way to collect media content from companies and store the collected data in a repository that may be accessible to social network platforms, where the media content may be retrieved and appended to a user post published on a social network platform.

According to at least one embodiment, a digital space (e.g., for images, photos, snapshots, animated gifs, videos, and other media content) may be provided in a user post on a social network platform in order to incentivize companies to create representative media content based on the content created by the user.

The present embodiment may include registering companies with a repository. The data stored in the repository by a registered company may include, brand images and logos, photos and videos of celebrity/model brand ambassadors, keywords (e.g., soda, pop, drink, beverage, ice, refreshing, thirsty) associated with products and/or services of the company, and user incentives for including the media content of the company in the user post. The registered company profile may also indicate the company bid or how much the company is willing to pay to have the media content of the company included in a user post. The company bid may depend on social network metrics, such as, the impressions, interactions, and reach of the specific user post. Additionally, the registered company profile may indicate the target audience (e.g., viewers of the user post) demographics (e.g., based on age, location, gender) for the products and/or services of the company.

According to one embodiment, social network platforms may be monitored to detect candidate user posts that have already been published and/or candidate user posts that have yet to be published. In addition to not having media content, detected candidate user posts may include user posts that have the potential to go viral or are trending, user posts from an influencer (e.g., posting users that have over 500,000 followers), and user posts that express a positive sentiment towards products and/or services of a company.

In at least one embodiment, a cognitive computing system may be provided to scan user posts in order to quantify sentiments expressed in the user posts and map out content with known labels/tags/keywords/descriptors associated with products and/or services of a company.

According to another embodiment, the media content appended to a user post may be dynamic on a per-viewer basis. As such, when a user post includes dynamic company media content, a first viewer of the user post may see media content from a first company whereas a second viewer of the user post may see media content from a second company based on learning that the second company may appeal more to the second viewer than the first company.

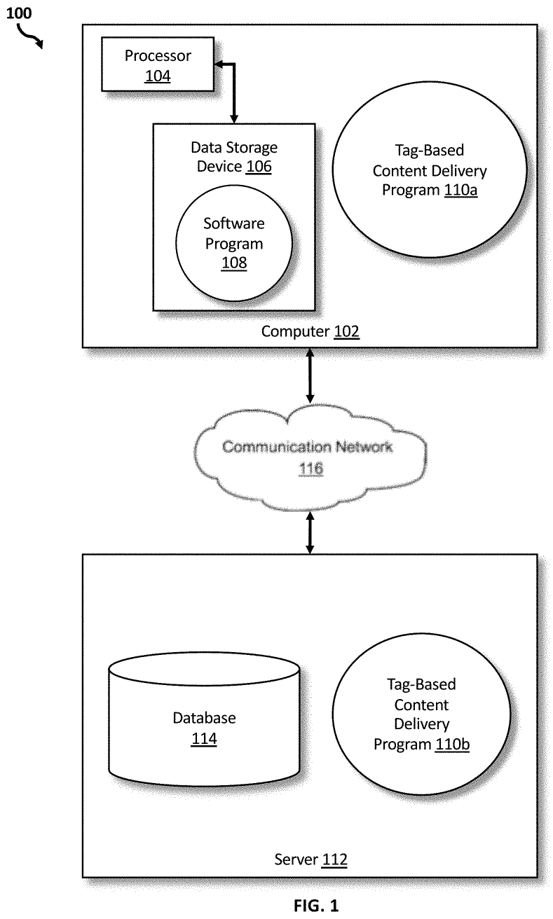

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a tag-based content delivery program 110a. The networked computer environment 100 may also include a server 112 that is enabled to run a tag-based content delivery program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

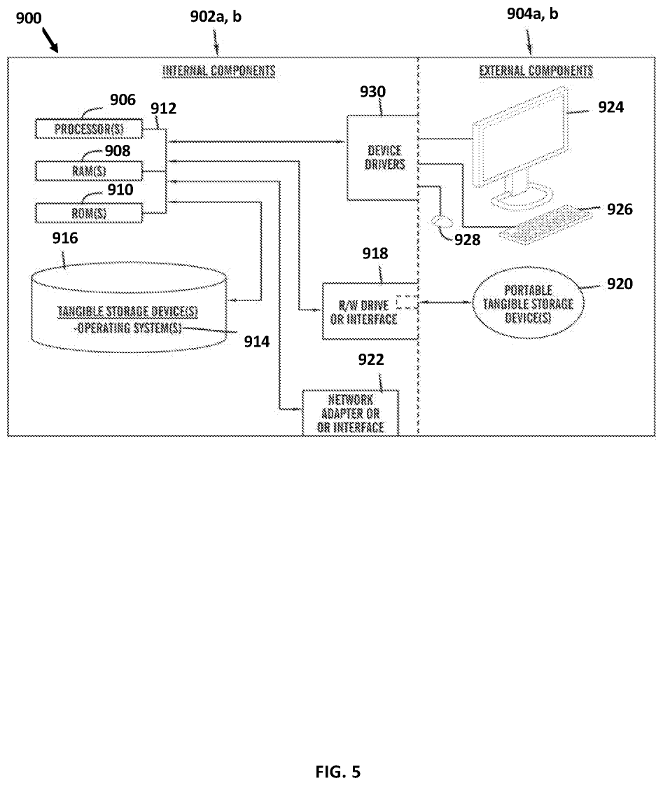

The client computer 102 may communicate with the server computer 112 via the communication network 116. The communication network 116 may include connections, such as wire, wireless communication links, or fiber optic cables. As will be discussed with reference to FIG. 5, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the tag-based content delivery program 110a, 110b may interact with a database 114 that may be embedded in various storage devices, such as, but not limited to a computer/mobile device 102, a networked server 112, or a cloud storage service.

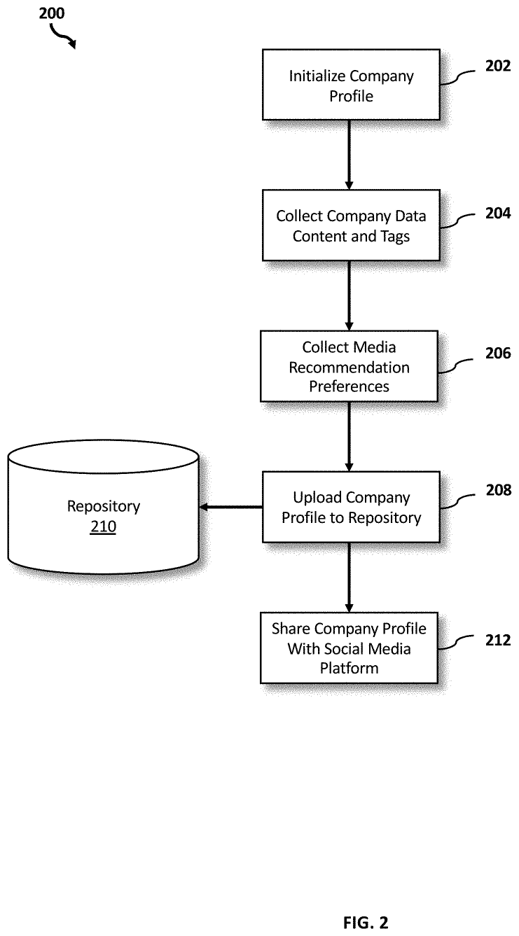

According to the present embodiment, a user using a client computer 102 or a server computer 112 may use the tag-based content delivery program 110a, 110b (respectively) to receive suggested media content for inclusion in a user post on a social network platform having no representative media content, where the suggested media content may be based on identified tags in the user post that may be linked to a product or service of a company. The media recommendation for social publishing method is explained in more detail below with respect to FIGS. 2-4.

Referring now to FIG. 2, an operational flowchart illustrating the exemplary tag-based content delivery company registration process 200 used by the tag-based content delivery program 110a, 110b according to at least one embodiment is depicted.

At 202, a company profile is initialized. Using a software program 108 on a company representative device (e.g., client computer 102), a company profile corresponding with the company associated with the company representative device may be initialized. The company profile may be implemented as a data structure (e.g., an array) with fields containing company data or pointers to company data. The initialized company profile may include a data file for storing authentication information (e.g., username and password) for accessing the company profile, contact information (e.g., corporate address, e-mail, phone number), and billing information (e.g., payment method, billing address).

For example, a company representative for the Burger Restaurant may interact with a company laptop and start the tag-based content delivery program 110a, 110b running on the company laptop. The tag-based content delivery program 110a, 110b may automatically present the company representative via the company laptop with an option to create a new company profile for the Burger Restaurant if none is found or may display a button or other way for the company representative to indicate a desire to create a new company profile. Once the company representative affirmatively indicates a desire to create a new company profile for the Burger Restaurant, a new data structure may be initialized for the company profile. Then, the tag-based content delivery program 110a, 110b may collect the authentication, contact, and billing information associated with the Burger Restaurant profile by presenting the company representative of the Burger Restaurant with a form having text fields for collecting the requested information. After the company representative of the Burger Restaurant submits the requested information by entering text into the respective text fields, the tag-based content delivery program 110a, 110b may store the requested information in a data file associated with the Burger Restaurant profile.

Next, at 204, company data content and tags are collected. After initializing the company profile at 202, the tag-based content delivery program 110a, 110b may collect data content associated with products and/or services of the company by providing the company representative with the option (e.g., via a dialog box) to select preexisting data content stored in the company representative device (e.g., client computer 102) or various storage devices linked to the company representative device. According to one embodiment, the tag-based content delivery program 110a, 110b may provide the company representative with the option (e.g., via a dialog box) to select pointers to data content stored in a cloud environment. According to another embodiment, the tag-based content delivery program 110a, 110b may also provide the company representative with the option (e.g., via a dialog box) to provide access to a camera attached to the company representative device (e.g., a camera linked to a laptop) to collect real-time media content (e.g., to capture a photo of a new company product). Then, the company representative may be given an option to indicate that the collected data content is satisfactory (e.g., via a preview box) and given the opportunity to resubmit the data content if the collected media content is unsatisfactory. Once the company representative approves the data content (e.g., clicking an “Accept” button in the preview box), the tag-based content delivery program 110a, 110b may provide the company representative with a text box to enter tags to be embedded with or associated with the collected data content. After the company data content and associated tags have been collected, the tag-based content delivery program 110a, 110b may add the collected data content and tags to the company profile.

According to one embodiment, the company data content may include media content or pointers to media content, such as, brand images, logos, product photos, celebrity/model endorser photos, videos, animated graphics (e.g., gifs), memes, slogans, live streams, or other suitable digital content. According to at least one embodiment, tags may include keywords, iconic symbols (e.g., emoticons/emojis), common themes, contexts, or other suitable descriptors associated with a product, service, or company.

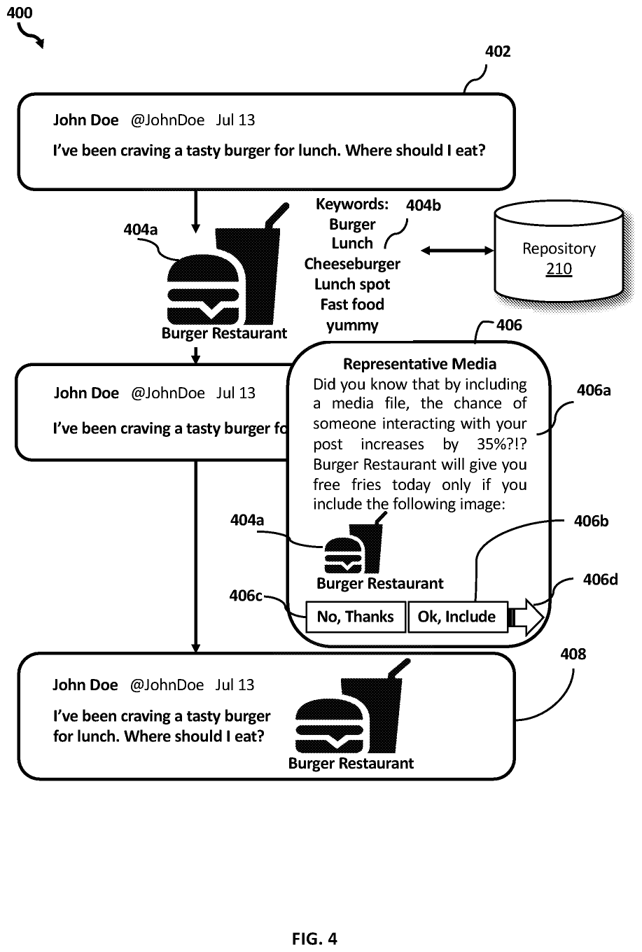

Continuing with the previous example, and with additional reference to FIG. 4, the tag-based content delivery program 110a, 110b may collect data content associated with the Burger Restaurant by transmitting, via communication network 116, a dialog box to the company laptop to prompt the company representative to select preexisting data content or to provide access to a camera attached to the company laptop to collect real-time media content. In response, the company representative may select a company logo 404a stored on the company laptop for collection by the tag-based content delivery program 110a, 110b. After the company representative reviews the company logo 404a depicted in a preview box and approves the media content by clicking an “Accept” button located in the preview box with a laptop mouse, the tag-based content delivery program 110a, 110b may provide the company representative with a text box to enter tags to be associated with the company logo 404a. In response, the company representative may textually enter tags in the form of keywords 404b into the text box. In one embodiment, the keywords 404b entered by the company representative may include “burger,” “lunch,” “cheeseburger,” “lunch spot,” “fast food,” and “yummy.” Thereafter, the tag-based content delivery program 110a, 110b may add the collected company logo 404a and keywords 404b to the Burger Restaurant company profile.

According to one embodiment, the tag-based content delivery program 110a, 110b may analyze the tags (e.g., via a cognitive computing system) entered by the company representative in the text box and automatically provide the company representative with tags that are similar or related in meaning to the tags entered by the company representative. The tags provided by the tag-based content delivery program 110a, 110b may be stored with the company profile as additional tags for the company media content. Continuing the previous example, the tag-based content delivery program 110a, 110b may analyze the keywords: “burger,” “lunch,” “cheeseburger,” “lunch spot,” “fast food,” and “yummy” entered by the company representative and provide the company representative with the related keywords: “hamburger,” “tasty,” and “delicious.”

Then, at 206, media recommendation preferences are collected. In one embodiment, the media recommendation preferences may relate to user incentives, company bid, and target audience demographics. The tag-based content delivery program 110a, 110b may collect media recommendation preferences by transmitting a collection interface (e.g., an input form) to the company representative device which the company representative may interact with by, for example, entering text into text fields or selecting from a predetermined list of answers.

The tag-based content delivery program 110a, 110b may provide a section in the collection interface (e.g., first page of an input form) to receive information from the company representative regarding specific user incentives that the company may offer to a user who agrees to include the company data content (e.g., media content) in the published user post. The tag-based content delivery program 110a, 110b may provide suggested user incentive categories which the company representative may select (e.g., via clicking a checkbox next to the user incentive category). The suggested user incentive categories may include among others, a percentage discount on a future purchase, a free product, a free accessory/related item, a digital coupon, a deal with a cross promoted item/opportunity, and company loyal points. The company representative may then textually enter the details or specifics for each selected incentive category. According to at least one embodiment, the tag-based content delivery program 110a, 110b may also provide the company representative with the option to select an “Other” user incentive category when the specific user incentive of the company cannot be properly indexed under one of the suggested user incentive categories provided by the tag-based content delivery program 110a, 110b. The company representative may then textually enter the details or specifics of the “Other” user incentive category (e.g., user entered to win a free trip).

When the company representative enters multiple user incentives in the collection interface of the tag-based content delivery program 110a, 110b, the company representative may indicate the specific user incentive to be provided to a user for a specific company media content. According to one embodiment, the tag-based content delivery program 110a, 110b may randomize the specific user incentive provided to the user with the company media content. In another embodiment, the tag-based content delivery program 110a, 110b may customize the specific user incentive provided to the user for a specific user post. In at least one embodiment, if the tag-based content delivery program 110a, 110b determines that a user post has the potential to reach a large audience (e.g., based on trending hashtag, influential user), the tag-based content delivery program 110a, 110b may provide the user with the specific user incentive with the highest value (e.g., monetary value).

Continuing with the previous example, the tag-based content delivery program 110a, 110b may provide an input form to the company representative of the Burger Restaurant including a first page for receiving information regarding specific user incentives. In response, the company representative may select a checkbox indicating a free product user incentive category and then textually enter “free fries” to specify the free product user incentive.

Additionally, the tag-based content delivery program 110a, 110b may provide a section in the collection interface (e.g., second page of the input form) to receive information from the company representative regarding how much the company is willing to pay to a social network platform to have the company media content associated with a published user post based on social network metrics such as, but not limited to: impressions (e.g., the number of times the company media content is displayed on a social network platform), interactions (e.g., the number of clicks or views the company media content receives), and reach (e.g., the number of unique viewers of the company media content). The tag-based content delivery program 110a, 110b may submit a query to obtain the social network metrics via an application programming interface (“API”) of a respective social network platform.

The company representative may enter the company bid into the collection interface provided by the tag-based content delivery program 110a, 110b in increments of a daily, weekly, monthly, or yearly budget. As such, once the company budget is depleted, the tag-based content delivery program 110a, 110b may not suggest the company media content to a user until the company budget is replenished. According to one embodiment, the company representative may enter the company bid in increments of a cost per user post. In such an embodiment, the company representative may specify the amount the company will pay each time the company media content is included in the published user post.

Continuing with the previous example, the tag-based content delivery program 110a, 110b may provide an input form to the company representative of the Burger Restaurant including a second page for receiving information regarding the company bid. In response, the company representative may enter a monthly company budget of $4,000 to have the company logo 404a included in the published user post.

The tag-based content delivery program 110a, 110b may also provide a section in the collection interface (e.g., third page of the input form) to receive information from the company representative regarding the attributes or demographics of the target audience of the company media content. In one embodiment, the target demographics may be indicated by the company representative in terms of age range, geographic location, gender, any other suitable attributes. The tag-based content delivery program 110a, 110b may provide checkboxes adjacent various demographic attributes (e.g., age range: 18-24; gender: male) which the company representative may click to select. According to at least one other embodiment, the tag-based content delivery program 110a, 110b may provide text fields in which the company representative may textually enter various demographic attributes.

Continuing with the previous example, the tag-based content delivery program 110a, 110b may provide an input form to the company representative of the Burger Restaurant including a third page for receiving information regarding the demographics of the target audience of the company media content. In response, the company representative may select the demographic attributes indicating, age range: 18-24; geographic location: United States of America; and gender: male and female, by clicking the respective checkboxes.

After the company media recommendation preferences (e.g., user incentives, company bid, and target audience demographics) have been collected, the tag-based content delivery program 110a, 110b may provide the company representative with a summary page including a summary of the collected information for review and approval. Once the company representative indicates approval of the collected information (e.g., via clicking the “Accept” button located in the summary page), the tag-based content delivery program 110a, 110b may add the collected media recommendation preferences to the company profile.

Continuing with the previous example, the tag-based content delivery program 110a, 110b may provide a summary page to the company representative of the Burger Restaurant including a summary of the collected user incentives, company bid, and target audience demographics information. After the company representative reviews the collected information in the summary page and clicks the “Accept” button located in the summary page, the tag-based content delivery program 110a, 110b may add the collected media recommendation preferences to the Burger Restaurant company profile.

Then, at 208, the company profile is uploaded to a repository 210 for storage. The tag-based content delivery program 110a, 110b may generate and maintain a data structure including the repository 210 for storing one or more company profiles. After the company profile is completed by the company representative, the company profile may be uploaded, via the communication network 116, to a cloud environment for storage on the repository 210. The tag-based content delivery program 110a, 110b may transmit the company profile from the company representative device (e.g., company laptop) to the repository 210 where social network platforms may access the company profile. In at least one embodiment, the repository 210 may be stored within database 114 on server 112. Continuing with the previous example, the tag-based content delivery program 110a, 110b may transmit the completed Burger Restaurant company profile via communications network 116 to the repository 210 for storage.

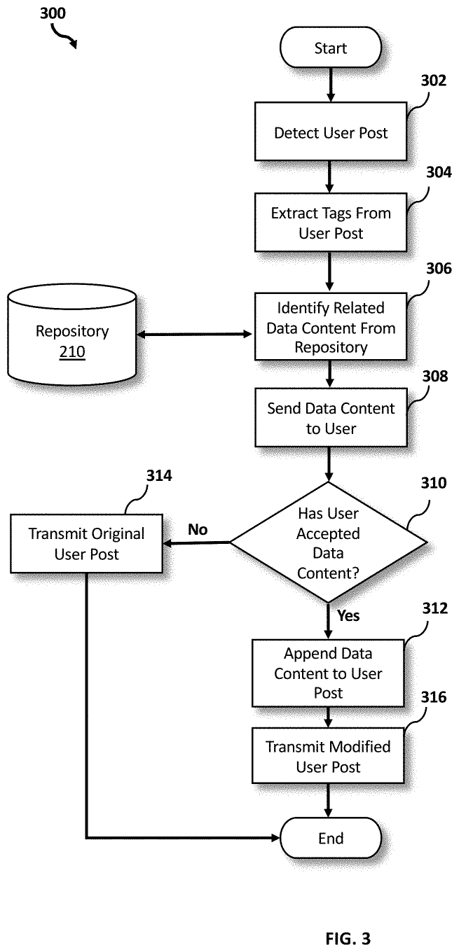

Next, at 212, the company profile is shared with a social network platform. The tag-based content delivery program 110a, 110b may provide an API to one or more social network platforms which may be integrated into a social publishing module of the respective social network platform. When the API provided by the tag-based content delivery program 110a, 110b is integrated into the social publishing module of the social network platform, the social network platform may access the repository 210 via the communication network 116. Specifically, the social network platform using the tag-based content delivery program 110a, 110b may access the repository 210 to retrieve the company profiles and associated data content (e.g., company media content) when a potential user post is detected, as will be detailed with reference to FIG. 3.

Referring now to FIGS. 3 and 4, an operational flowchart (FIG. 3) and an operational example (FIG. 4) illustrating the exemplary media recommending process 300, 400 used by the tag-based content delivery program 110a, 110b according to at least one embodiment is depicted.

At 302, a user post is detected. The user post may be detected in a social network platform by the tag-based content delivery program 110a, 110b when the user post lacks any associated (e.g., representative) media content. According to one embodiment, the tag-based content delivery program 110a, 110b may be integrated into the social network platform via an API and may access the real-time user activity of the social network platform. With access to the real-time user activity, the tag-based content delivery program 110a, 110b may scan (e.g., via a cognitive computing system) publicly published user posts to detect user posts that include no associated media content (e.g., text-only user posts, user posts with only text and iconic symbols). In at least one embodiment, the tag-based content delivery program 110a, 110b may monitor the real-time user activity of the social network platform and scan (e.g., via a cognitive computing system) proposed user posts or user posts being received by the social network platform, before the user post is published, to find user posts that include no associated media content.

According to one embodiment, if the tag-based content delivery program 110a, 110b detects a user post with associated media content, the tag-based content delivery program 110a, 110b may ignore the user post and continue onto another user post. In at least one embodiment, associated media content in a user post may include, images, videos, graphics, or other digital content representative of the user post (e.g., a user post reviewing a sushi restaurant including a photo of a sushi roll).

Continuing with the previous example, a social network platform may receive a user post 402 from a user John Doe. The tag-based content delivery program 110a, 110b integrated into the social network platform via an API may apply a cognitive computing system to scan John Doe's user post and detect that John Doe's user post, “I've been craving a tasty burger for lunch. Where should I eat?” is a text-only user post that lacks associated media content.

According to at least one embodiment, the tag-based content delivery program 110a, 110b may rank the detected user posts (e.g., user posts with no representative media content) based on measuring the potential of the detected user posts to reach a large audience on the social network platform. In one embodiment, the tag-based content delivery program 110a, 110b may rank the detected user posts by measuring the potential of the detected user posts to go viral based on monitoring trending hashtags or topics. In another embodiment, the tag-based content delivery program 110a, 110b may request user influencer data from the social network platform and may analyze the user influencer data to identify influential users on the social network platform (e.g., users that have over 500,000 followers). Then, the tag-based content delivery program 110a, 110b may rank the detected user posts according to the relative influence level of the posting users. The tag-based content delivery program 110a, 110b may automatically prioritize the detected user posts with the highest calculated rankings and prioritize the respective posting users for receiving the company data content from repository 210. In at least one embodiment, the tag-based content delivery program 110a, 110b may only view or consider user posts by users above a threshold influence level (e.g., users that have over 700,000 followers), which may be pre-defined by the company representative of a company during the tag-based content delivery company registration process 200.

Then, at 304, one or more tags are extracted from the detected user post. After the tag-based content delivery program 110a, 110b detects a user post with no associated media content on the social network platform, the tag-based content delivery program 110a, 110b may parse through the non-media content (e.g., text, iconic symbols) of the user post via natural-language processing or any cognitive computing system to identify and extract tags (e.g., keywords, iconic symbols) from the content of the user post. Specifically, the tag-based content delivery program 110a, 110b may identify the topic(s) expressed in the user post. Then, the tag-based content delivery program 110a, 110b may segment the user post into one or more elements or terms (e.g., keywords and/or iconic symbols). Thereafter, the tag-based content delivery program 110a, 110b may determine and identify the keywords and/or iconic symbols that most closely represent the topic(s) expressed in the user post and extract the identified keywords and/or iconic symbols as tags.

Continuing with the previous example, the tag-based content delivery program 110a, 110b may parse through John Doe's user post 402 using natural-language processing and identify food as the topic expressed in John Doe's user post 402. Then, the tag-based content delivery program 110a, 110b may segment the text in John Doe's user post 402 into the individual words and extract the keywords “tasty,” “burger,” “lunch,” and “eat” as the terms that most closely represent the topic of food.

Additionally, the tag-based content delivery program 110a, 110b may apply natural-language processing or any cognitive computing system to perform a sentiment analysis of the detected user post. The tag-based content delivery program 110a, 110b may perform sentiment analysis of the detected user post to determine the polarity of the detected user post, specifically, whether the mood/opinion of the detected user post is positive, negative, or neutral towards the expressed topic(s). If the tag-based content delivery program 110a, 110b determines that the polarity of the detected user post is negative, the tag-based content delivery program 110a, 110b may register the detected user post as a negative candidate and remove the detected user post from a queue of candidates for receiving company media content. In one embodiment, if the tag-based content delivery program 110a, 110b determines that the polarity of the detected user post is positive, the tag-based content delivery program 110a, 110b may automatically prioritize the detected user post and prioritize the respective posting user for receiving the company data content from repository 210.

Continuing with the previous example, if the tag-based content delivery program 110a, 110b detects a user post in a social network platform that recites “My soda tasted bad,” the tag-based content delivery program 110a, 110b may perform sentiment analysis of the detected user post and identify the expressed topics of soda, taste, and bad. Based on the context of the topics expressed in the detected user post, the tag-based content delivery program 110a, 110b may determine that the polarity of the detected user post is negative. Given the negative polarity, the tag-based content delivery program 110a, 110b may remove the detected user post as a candidate for receiving company media content.

Then, at 306, data content related to the extracted tags are identified in the repository 210. After the tag-based content delivery program 110a, 110b extracts tags (e.g., keywords, iconic symbols) from the detected user post, the tag-based content delivery program 110a, 110b may perform, via communication network 116, a database query of the repository 210 to identify records of the extracted tags in the repository 210. In performing the database query of the repository 210, the tag-based content delivery program 110a, 110b may transmit a search request (e.g., via communication network 116) including the extracted tags. The tag-based content delivery program 110a, 110b may filter through the tags and preferences stored as part of the company profiles in the repository 210 to identify the tags that match the extracted tags and company media recommendation preferences that match the attributes or demographics of the posting user and user's audience. After the matching tags are identified in the repository 210, the tag-based content delivery program 110a, 110b may identify the company data content (e.g., media content or pointers to media content) in the repository 210, linked to the matching tags.

In at least one embodiment, the tag-based content delivery program 110a, 110b may analyze (e.g., via a cognitive computing system) the extracted tags from the detected user post and determine additional tags that are similar to or related in meaning to the extracted tags. Thereafter, the tag-based content delivery program 110a, 110b may transmit a search request (e.g., via communication network 116) of the repository 210 including both the extracted tags and the determined additional tags, in order to increase the probability of identifying matching tags in the repository 210.

Continuing with the previous example, after the tag-based content delivery program 110a, 110b extracts the keywords “tasty,” “burger,” “lunch,” and “eat” from John Doe's user post 402, the tag-based content delivery program 110a, 110b may transmit a search request, via communication network 116, of the repository 210 including the extracted keywords. In one embodiment, the tag-based content delivery program 110a, 110b may apply a cognitive computing system to analyze the extracted keywords and determine the additional keywords, “cheeseburger,” “fast food,” and “yummy” as being similar to or related in meaning to the extracted keywords. Then, the tag-based content delivery program 110a, 110b may transmit a search request, via communication network 116, of the repository 210 including both the extracted keywords and the determined additional keywords. As a result of the search request, the tag-based content delivery program 110a, 110b may identify a matching set of keywords 404b in the repository 210 and the associated company media content 404a of the Burger Restaurant.

Then, at 308, the data content is sent to the user. The tag-based content delivery program 110a, 110b may transmit (e.g., via communication network 116) an alert or push notification to the user device (e.g., laptop) to suggest representative data content (e.g., media content or pointers to media content) for inclusion in the user post. The representative data content provided by the tag-based content delivery program 110a, 110b may be the company media content or pointers to company media content identified in the repository 210 by the tag-based content delivery program 110a, 110b based on a search of the extracted keywords from the user post. In one embodiment, the tag-based content delivery program 110a, 110b may prompt the user with the suggested representative media content (e.g., via a floating dialog box depicted on the display of the user's device). In the floating dialog box, for example, the tag-based content delivery program 110a, 110b may include a preview of the suggested media content and a description of the available user incentive for including the suggested media content in the user post. In one embodiment, the tag-based content delivery program 110a, 110b may provide multiple representative company data content sorted by relevancy. In at least one embodiment, the tag-based content delivery program 110a, 110b may provide the user with an option to accept or decline the suggested media content (e.g., via clicking the “Accept” or “Decline” buttons located in the floating dialog box). In another embodiment, the tag-based content delivery program 110a, 110b may provide the user with an option to consider multiple suggested media content (e.g., via clicking next button).

Continuing with the previous example, the tag-based content delivery program 110a, 110b may transmit, via communication network 116, a push notification to John Doe's laptop. Specifically, the tag-based content delivery program 110a, 110b may provide a floating dialog box 406 on the display of John Doe's laptop including the company media content 404a of the Burger Restaurant, based on the search of repository 210 and the identified keywords 404b. In the floating dialog box 406, the tag-based content delivery program 110a, 110b may include a preview of the suggested media content 404a and a description of an available user incentive 406a for including the suggested media content 404a in the user post of John Doe. Further, the tag-based content delivery program 110a, 110b may include clickable action buttons 406b, 406c, 406d in the floating dialog box 406 to enable John Doe to accept the media content by clicking the “Ok, Include” button 406b in the floating dialog box 406, decline the media content by clicking the “No, Thanks” button 406c in the floating dialog box 406, or review additional available media content by clicking the arrow button 406d in the floating dialog box 406.

Then, at 310, the tag-based content delivery program 110a, 110b determines if the user has accepted the data content. The tag-based content delivery program 110a, 110b may determine that the user has accepted the suggested data content (e.g., media content or pointer to media content) if the user selects the option in the alert or push notification indicating an agreement to include the suggested data content in the user post. In one embodiment, the user may select the first suggested data content provided by the tag-based content delivery program 110a, 110b. In another embodiment, the user may review (e.g., via scrolling) the multiple suggested media content provided by the tag-based content delivery program 110a, 110b before selecting a media content for inclusion in the user post. Further, the tag-based content delivery program 110a, 110b may determine that the user has declined the suggested media content if the user selects the option in the alert or push notification indicating that the user does not wish to include the suggested media content in the user post.

If the tag-based content delivery program 110a, 110b determines that the user has not accepted (e.g., declined) the suggested data content (e.g., media content or pointer to media content), based on the user selecting the decline option in the alert or push notification at 310 (e.g., floating dialog box), then the tag-based content delivery program 110a, 110b will transmit the original user post at 314. Specifically, the tag-based content delivery program 110a, 110b may transmit the user post, without associated data content, to the social network platform for publishing. In one embodiment, if the tag-based content delivery program 110a, 110b determines that the user has declined the suggested data content, based on the user selecting the decline option in the alert or push notification, the tag-based content delivery program 110a, 110b may provide the user with alternative suggested data content in the floating dialog box. Then, if the tag-based content delivery program 110a, 110b determines that the user has declined the alternative suggested data content, the tag-based content delivery program 110a, 110b may be triggered to transmit the original user post, without associated company data content, to the social network platform for publishing.

Continuing with the previous example, in response to receiving the push notification from the tag-based content delivery program 110a, 110b via the floating dialog box 406 on the display of the laptop used by John Doe, John Doe may select, via a laptop mouse, “Ok, Include” button 406b to accept the media content, “No, Thanks” button 406c to decline the media content, or the arrow button 406d to review additional available media content. If John Doe selects the “No, Thanks” button 406c, the tag-based content delivery program 110a, 110b may determine that John Doe has declined the suggested media content and may be triggered to transmit John Doe's original user post 402, without associated media content, to the social network platform for publishing.

If, however, the tag-based content delivery program 110a, 110b determines that the user has accepted the suggested data content (e.g., media content or pointer to media content), based on the user selecting the accept option in the alert or push notification at 310 (e.g., floating dialog box), then the tag-based content delivery program 110a, 110b will append the data content to the user post at 312. In one embodiment, the tag-based content delivery program 110a, 110b may retrieve the accepted media content or pointer to the accepted media content from the repository 210 (e.g., via communication network 116) and may dynamically modify the user post by attaching the media content to the user post and resizing the media content and/or the text of the user post as necessary for viewing.

Continuing with the previous example, if John Doe selects the “Ok, Include” button 406b, the tag-based content delivery program 110a, 110b may determine that John Doe has accepted the suggested media content 404a. As a result, the tag-based content delivery program 110a, 110b may be triggered to retrieve the accepted media content 404a from the repository 210, via communication network 116, and dynamically modify John Doe's user post. Specifically, the tag-based content delivery program 110a, 110b may attach the media content 404a to John Doe's user post and resize the media content 404a and the text of John Doe's user post.

Next, at 316, the modified user post is transmitted. After the tag-based content delivery program 110a, 110b appends the accepted media content to the user post and resizes the accepted media content and/or the text of the user post as necessary, the tag-based content delivery program 110a, 110b may transmit (e.g., via communication network 116) the modified user post to the social network platform for publishing. Thereafter, the tag-based content delivery program 110a, 110b may render the modified user post visible to the user via the user device display and visible to the audience of the user on the social network platform. The tag-based content delivery program 110a, 110b may then provide the user with a way to redeem the user incentive. In one embodiment, the tag-based content delivery program 110a, 110b may access a user profile of the user associated with the social network platform to obtain user contact information. The user contact information may include the user e-mail address and/or the user telephone number via which the tag-based content delivery program 110a, 110b may provide the user incentive to the user (e.g., via e-mailing or text messaging digital coupon). The tag-based content delivery program 110a, 110b may also access the user profile to learn one or more user preferences. In one embodiment, the user preferences may indicate the preferred user contact method (e.g., text message instead of e-mail) and user incentive preferences (e.g., the user is gluten-free). Based on learning the user preferences, the tag-based content delivery program 110a, 110b may determine the best available user incentive to provide the user (e.g., gluten-free menu item) and the best way to provide the user with the user incentive (e.g., via text messaging digital coupon).

Continuing with the previous example, after the tag-based content delivery program 110a, 110b attaches the media content 404a of the Burger Restaurant to John Doe's user post and resizes the media content 404a and the text of John Doe's user post, the tag-based content delivery program 110a, 110b may transmit the modified user post 408, via communication network 116, to the social network platform for publishing. Thereafter, the tag-based content delivery program 110a, 110b may render the modified user post 408 visible to John Doe via the display of John Doe's laptop and visible to the audience of John Doe on the social network platform. Then, the tag-based content delivery program 110a, 110b may obtain John Doe's e-mail address from John Doe's user profile on the social network platform and may e-mail John Doe a digital coupon for free fries, as indicated to be the specific user incentive 406a for including the media content 404a of the Burger Restaurant in John Doe's user post.

As described herein, the tag-based content delivery program 110a, 110b may have the capacity to improve the technical field of digital communication by infusing media content into digital communications within a social network platform in order to increase engagement among users of the social network platform. Specifically, the tag-based content delivery program 110a, 110b may enable detecting a user post on a social network platform having no associated media content and automatically delivering incentive-backed media content for inclusion in the user post, based on a determination of the topic(s) disclosed in the user post.

According to another embodiment, the tag-based content delivery program 110a, 110b may append a dynamic media content on a user post, such that the media content may change on a per-viewer basis. Specifically, the tag-based content delivery program 110a, 110b may receive internet history data (e.g., web cookie, browser cache) regarding the audience of the user post on the social network platform. Based on the audience internet history data, the tag-based content delivery program 110a, 110b may learn that a first viewer in the audience prefers a first company or brand and a second viewer in the audience prefers a second company or brand. As such, when the tag-based content delivery program 110a, 110b includes a dynamic media content on a user post, the tag-based content delivery program 110a, 110b may modify the media content so that the first viewer of the user post may see media content from the first company and the second viewer of the user post may see media content from the second company.

It may be appreciated that FIGS. 3 and 4 provide only an illustration of one embodiment and do not imply any limitations with regard to how different embodiments may be implemented. Many modifications to the depicted embodiment(s) may be made based on design and implementation requirements.

FIG. 5 is a block diagram 900 of internal and external components of computers depicted in FIG. 1 in accordance with an illustrative embodiment of the present invention. It should be appreciated that FIG. 5 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 5. Each of the sets of internal components 902 a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108 and the tag-based content delivery program 110a in client computer 102, and the tag-based content delivery program 110b in network server 112, may be stored on one or more computer-readable tangible storage devices 916 for execution by one or more processors 906 via one or more RAMs 908 (which typically include cache memory). In the embodiment illustrated in FIG. 5, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the tag-based content delivery program 110a, 110b can be stored on one or more of the respective portable computer-readable tangible storage devices 920, read via the respective R/W drive or interface 918 and loaded into the respective hard drive 916.

Each set of internal components 902 a, b may also include network adapters (or switch port cards) or interfaces 922 such as a TCP/IP adapter cards, wireless wi-fi interface cards, or 3G or 4G wireless interface cards or other wired or wireless communication links. The software program 108 and the tag-based content delivery program 110a in client computer 102 and the tag-based content delivery program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the tag-based content delivery program 110a in client computer 102 and the tag-based content delivery program 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

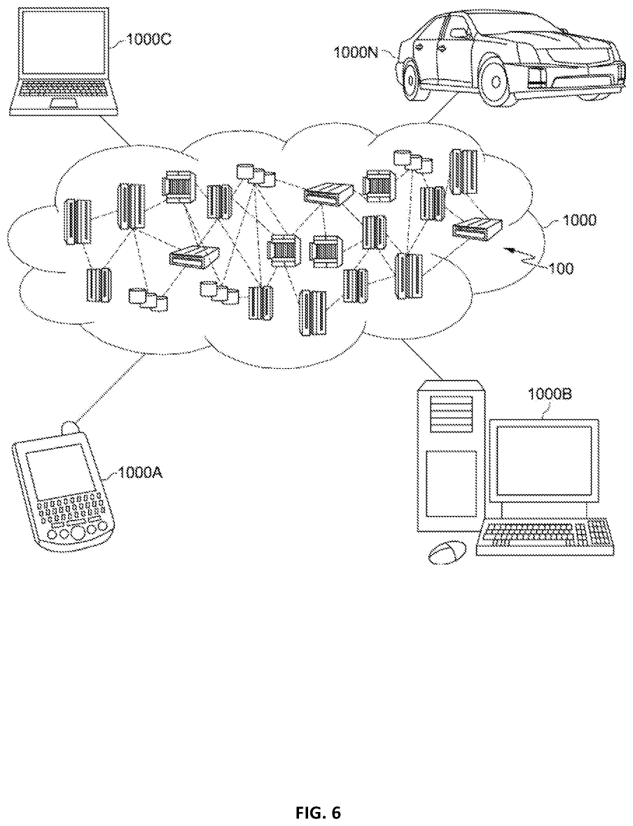

Referring now to FIG. 6, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 6 are intended to be illustrative only and that computing nodes 100 and cloud computing environment 1000 can communicate with any type of computerized device over any type of network and/or network addressable connection (e.g., using a web browser).

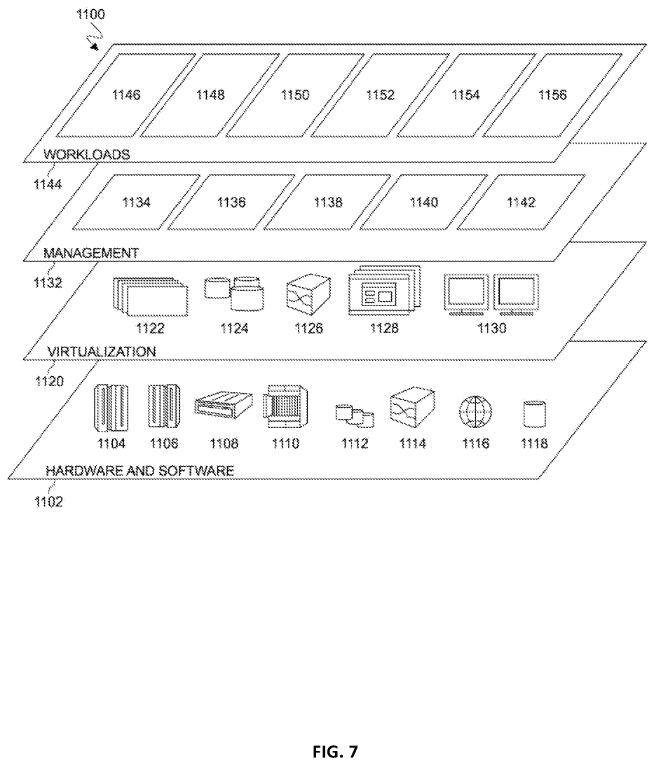

Referring now to FIG. 7, a set of functional abstraction layers 1100 provided by cloud computing environment 1000 is shown. It should be understood in advance that the components, layers, and functions shown in FIG. 7 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and media recommendation delivery 1156. A tag-based content delivery program 110a, 110b provides a way to detect a user post on a social network platform having no media content and generate a platform through which companies may provide the user with representative media content for inclusion in the user post based on identified tags in the user post, where the representative media content is associated with products or services of a company.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for recommending a media content for social media publishing, the method comprising:
detecting a user post on a social network platform;
extracting a tag from the detected user post, wherein the extracted tag is representative of a topic identified in the detected user post;
identifying a data content in a repository related to the extracted tag;
sending the identified data content to a user device for inclusion in the detected user post upon a user approval;
in response to receiving the user approval, modifying the detected user post by appending the identified data content to the detected user post; and
transmitting the modified user post to the social network platform.

2. The method of claim 1, further comprising:
segmenting the detected user post, wherein the segmented user post includes a plurality of terms; and
determining at least one term of the plurality of terms that is representative of the topic identified in the segmented user post.

3. The method of claim 1, further comprising:
analyzing the extracted tag of the detected user post;
determining at least one additional tag related to the extracted tag; and
transmitting a search request of the repository, wherein the transmitted search request includes the extracted tag of the detected user post and the at least one additional tag related to the extracted tag.

4. The method of claim 1, wherein the data content in the repository is selected from a group consisting of an image, a video, a live stream, an animated graphic, a meme, a logo, a slogan, and a pointer to a media content.

5. The method of claim 1, wherein the extracted tag is selected from a group consisting of a keyword, a common theme, a context, an iconic symbol, and a descriptor.

6. The method of claim 1, further comprising:
registering a company profile;
collecting the data content associated with the registered company profile;
collecting the tag related to the collected data content;
collecting a user incentive linked to the collected data content;
storing the registered company profile, the collected data content, the collected tag, and the collected user incentive in the repository; and
sharing the stored company profile, the stored data content, the stored tag, and the stored user incentive with the social network platform.

7. The method of claim 1, further comprising:
performing a sentiment analysis of the detected user post to determine a polarity of the topic identified in the detected user post, wherein the determined polarity is selected from a group consisting of a positive polarity, a negative polarity, and a neutral polarity.

8. The method of claim 7, further comprising:
in response to determining the polarity of the identified topic in the detected user post to be the negative polarity, removing the detected user post from a queue of candidates for receiving the data content from the repository.

9. The method of claim 7, further comprising:
in response to determining the polarity of the identified topic in the detected user post to be the positive polarity, prioritizing the detected user post in a queue of candidates for receiving the data content from the repository.

10. A computer system for recommending a media content for social media publishing, comprising:
one or more processors, one or more computer-readable memories, one or more computer-readable tangible storage media, and program instructions stored on at least one of the one or more computer-readable tangible storage media for execution by at least one of the one or more processors via at least one of the one or more memories, wherein the computer system is capable of performing a method comprising:
detecting a user post on a social network platform;
extracting a tag from the detected user post, wherein the extracted tag is representative of a topic identified in the detected user post;
identifying a data content in a repository related to the extracted tag;
sending the identified data content to a user device for inclusion in the detected user post upon a user approval;
in response to receiving the user approval, modifying the detected user post by appending the identified data content to the detected user post; and
transmitting the modified user post to the social network platform.

11. The computer system of claim 10, further comprising:
segmenting the detected user post, wherein the segmented user post includes a plurality of terms; and
determining at least one term of the plurality of terms that is representative of the topic identified in the segmented user post.

12. The computer system of claim 10, further comprising:
analyzing the extracted tag of the detected user post;
determining at least one additional tag related to the extracted tag; and
transmitting a search request of the repository, wherein the transmitted search request includes the extracted tag of the detected user post and the at least one additional tag related to the extracted tag.

13. The computer system of claim 10, wherein the data content in the repository is selected from a group consisting of an image, a video, a live stream, an animated graphic, a meme, a logo, a slogan, and a pointer to a media content.

14. The computer system of claim 10, wherein the extracted tag is selected from a group consisting of a keyword, a common theme, a context, an iconic symbol, and a descriptor.

15. The computer system of claim 10, further comprising:
registering a company profile;
collecting the data content associated with the registered company profile;
collecting the tag related to the collected data content;
collecting a user incentive linked to the collected data content;
storing the registered company profile, the collected data content, the collected tag, and the collected user incentive in the repository; and
sharing the stored company profile, the stored data content, the stored tag, and the stored user incentive with the social network platform.

16. The computer system of claim 10, further comprising:
performing a sentiment analysis of the detected user post to determine a polarity of the topic identified in the detected user post, wherein the determined polarity is selected from a group consisting of a positive polarity, a negative polarity, and a neutral polarity.

17. A computer program product for recommending a media content for social media publishing, comprising:
one or more computer-readable tangible storage media and program instructions stored on at least one of the one or more computer-readable tangible storage media, the program instructions executable by a processor to cause the processor to perform a method comprising:
detecting a user post on a social network platform;
extracting a tag from the detected user post, wherein the extracted tag is representative of a topic identified in the detected user post;
identifying a data content in a repository related to the extracted tag;
sending the identified data content to a user device for inclusion in the detected user post upon a user approval;
in response to receiving the user approval, modifying the detected user post by appending the identified data content to the detected user post; and
transmitting the modified user post to the social network platform.

18. The computer program product of claim 17, further comprising:
segmenting the detected user post, wherein the segmented user post includes a plurality of terms; and
determining at least one term of the plurality of terms that is representative of the topic identified in the segmented user post.

19. The computer program product of claim 17, further comprising:
analyzing the extracted tag of the detected user post;
determining at least one additional tag related to the extracted tag; and
transmitting a search request of the repository, wherein the transmitted search request includes the extracted tag of the detected user post and the at least one additional tag related to the extracted tag.

20. The computer program product of claim 17, further comprising:
registering a company profile;
collecting the data content associated with the registered company profile;
collecting the tag related to the collected data content;
collecting a user incentive linked to the collected data content;
storing the registered company profile, the collected data content, the collected tag, and the collected user incentive in the repository; and
sharing the stored company profile, the stored data content, the stored tag, and the stored user incentive with the social network platform.
